(19) United States
(12) Patent Application Publication
(10) Pub. No.: US 2014/0093204 A1
(43) Pub. Date: Apr. 3, 2014

(54) OPTICAL COUPLING DEVICE

(71) Applicant: HON HAI PRECISION INDUSTRY CO., LTD., New Taipei (TW)

(72) Inventor: CHANG-WEI KUO, New Taipei (TW)

(73) Assignee: HON HAI PRECISION INDUSTRY CO., LTD., New Taipei (TW)

(21) Appl. No.: 13/855,735

(22) Filed: Apr. 3, 2013

(30) Foreign Application Priority Data
Sep. 28, 2012 (TW) 101135779

(51) Int. Cl. G02B 6/32

(52) U.S. Cl. CPC G02B 6/32
USPC 385/33

(57) ABSTRACT

An optical coupling device includes a main body and a substrate. The main body includes a lens portion and two connecting portions. The lens portion has a bottom surface with first light converging portions thereon, a side surface with second light converging portions thereon, and a reflecting surface connected to the bottom surface and the side surface. The substrate has a top wall, a bottom wall, and a contacting wall. The top wall defines a notch passing through the contacting wall and a slot passing through the bottom wall and communicating with the notch. The notch detachably receives the main body. The first light converging portions are exposed from the bottom wall through the slot. The second light converging portions are exposed from the contacting wall through the notch.

### BACKGROUND

1. Technical Field

The present disclosure relates to an optical coupling device.

2. Description of Related Art

An optical signal transmission system includes a number of optical fibers and an optical coupling device. The optical coupling device includes a main body and a substrate. The main body converges light rays into or from the optical fibers, and also bends transmission paths of the light rays. The substrate loads the main body and aligns the main body with the optical fibers. However, the main body and the substrate are integrally formed, and made by an injection molding method. Therefore, it is very difficult to control the designate precision of the molding core of the optical coupling device, and the quality of the optical coupling device is influenced.

Therefore, it is desirable to provide an optical coupling device that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of an optical coupling device, according to an exemplary embodiment.

FIG. 2 is a schematic, exploded view of the optical coupling device of FIG. 1.

FIG. 3 is a schematic view of a main body of the optical coupling device of FIG. 1.

FIG. 4 is similar to FIG. 1, but viewed from another view.

FIG. 5 is a schematic, exploded view of the optical coupling device of FIG. 4.

FIG. 6 is a cross-sectional view of the optical coupling device taken along a line VI-VI of FIG. 1.

### DETAILED DESCRIPTION

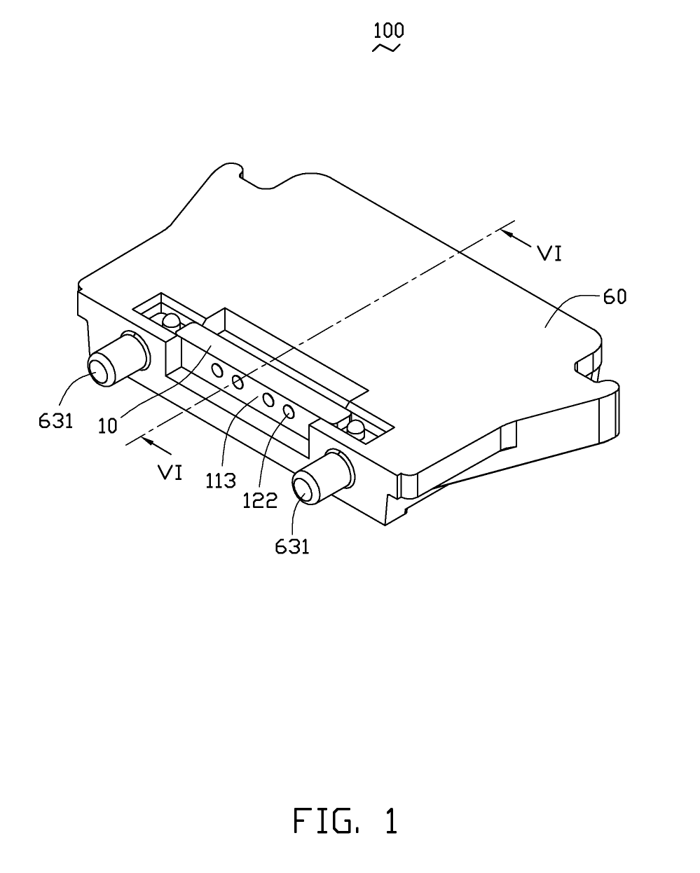

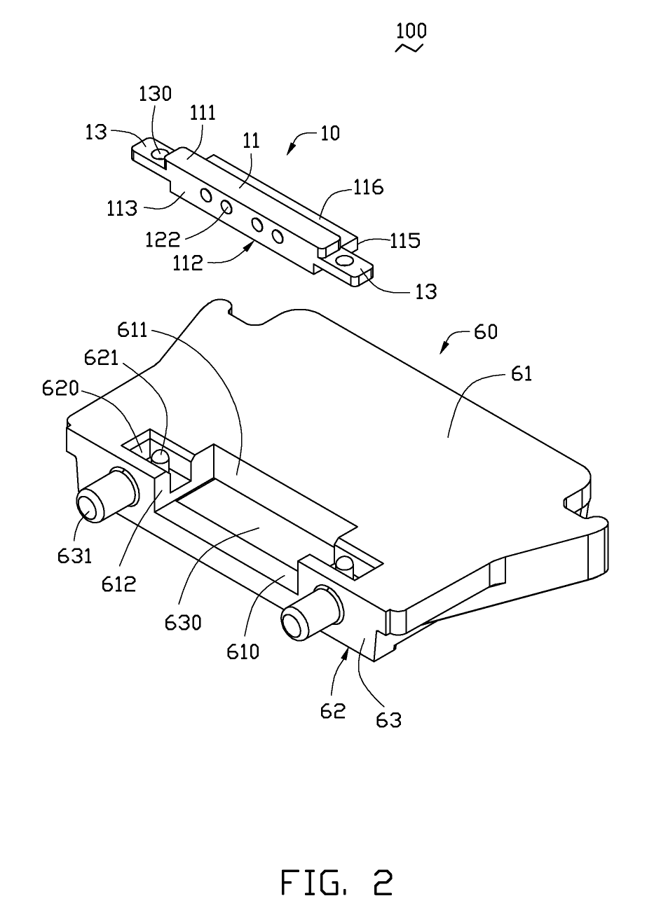

FIG. 1 and FIG. 2 illustrate an optical coupling device 100 in accordance with an embodiment. The optical coupling device 100 includes a main body 10 and a substrate 60.

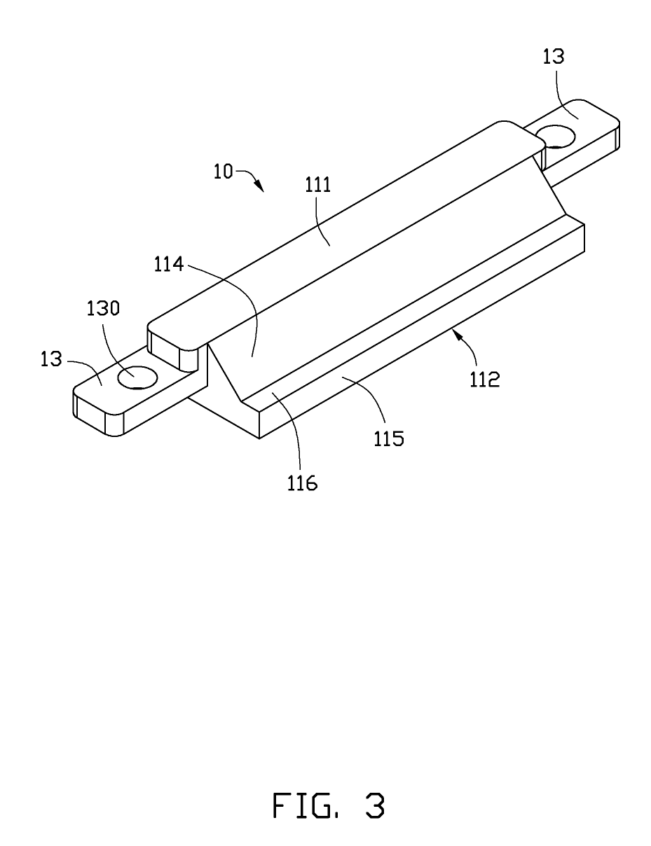

The main body 10 is made of transparent material, and includes a lens portion 11 and two connecting portions 13 connecting to the lens portion 11. Each of the connecting portions 13 has a first locating element 130. In the illustrated embodiment, the first locating element 130 is a through hole. FIG. 3 shows that the lens portion 11 includes a top surface 111, a bottom surface 112, a side surface 113, a reflecting surface 114, an abutting surface 115, and a connecting surface 116. The bottom surface 112 is opposite to and is parallel to the top surface 111. The side surface 113 is perpendicularly connected to the top surface 111 and the bottom surface 112. The reflecting surface 114 is connected to an incline to the top surface 111 and the connecting surface 116. An included angle formed between the reflecting surface 114 and the top surface 111 is about 135 degrees. An included angle formed between the reflecting surface 114 and the bottom surface 112 is about 45 degrees. The abutting surface 115 is opposite to and is parallel to the side surface 113. The connecting surface 116 is connected to the abutting surface 115, and is parallel to the top surface 111. In this embodiment, the lens portion 11 is integrally formed with the two connecting portions 13, and the two connecting portions 13 extend from two opposite sides of the lens portion 11. The number of the connecting portions 13 is not limited to this embodiment.

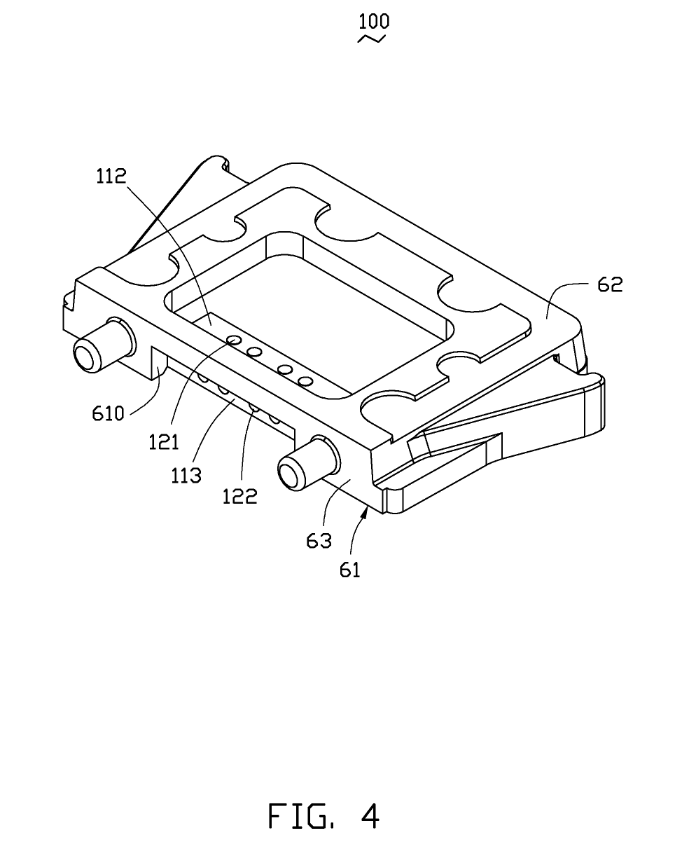

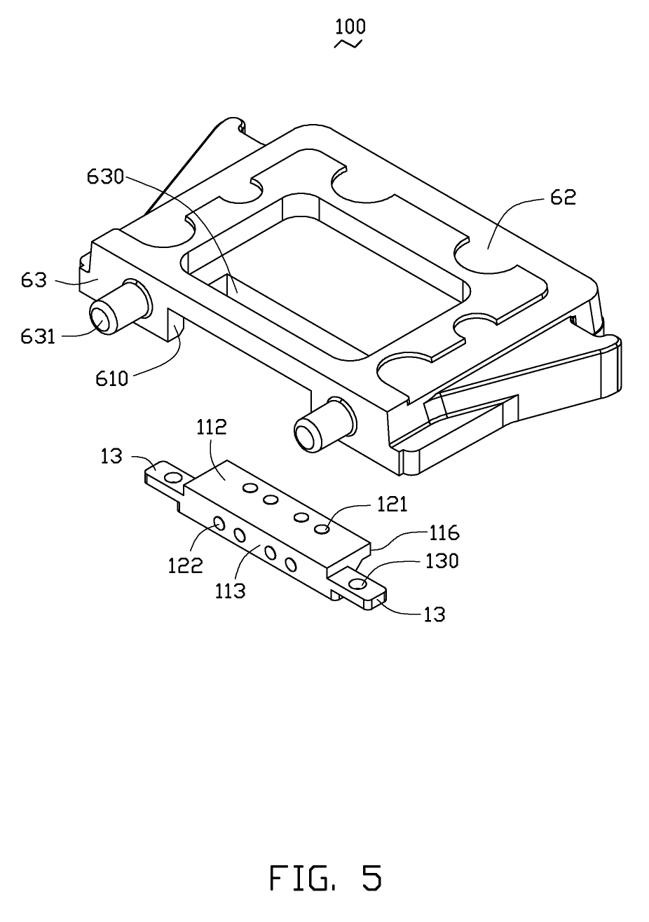

Also referring to FIGS. 4-5, a number of first converging portions 121 are positioned on the bottom surface 112. A number of second converging portions 122 are positioned on the side surface 113 corresponding to the first converging portions 121. The reflecting surface 114 is used for reflecting the light rays from the first converging portions 121 to the corresponding second converging portions 122, and is further used for reflecting the light rays from the second converging portions 122 to the corresponding first converging portions 121.

The substrate 60 includes a top wall 61, a bottom wall 62, and a contacting wall 63. The bottom wall 62 is opposite to the top wall 61. The contacting wall 63 is perpendicularly connected to the top wall 61 and the bottom wall 62. The top wall 61 defines a notch 610 passing through the contacting wall 63. The notch 610 includes a first sidewall 611 and two opposite second sidewalls 612. The first sidewall 611 is perpendicularly connected to the two second sidewalls 612. Each of the two second sidewalls 612 defines a fixing groove 620 passing through the top surface 61. The fixing groove 620 communicates with the notch 610. A second locating element 621 is received in each of the two fixing grooves 620. In the illustrated embodiment, the second locating element 621 is a pole. The substrate 60 defines a slot 630 passing through the bottom wall 62 and communicating with the notch 610. The slot 630 is adjacent to the first sidewall 611. The length and width of the bottom surface 112 of the lens portion 11 are substantially equal to the length and width of the slot 630 respectively, and thus the shape of the lens portion 11 is a fit with the shape of the slot 630. The number of the fixing grooves 620 and the number of the second locating elements 621 are not limited to this embodiment.

Two third locating elements 631 are positioned on the contacting wall 63, and correspond to two fourth locating elements of an optical fiber connector (not shown), and thus the optical coupling device 100 can be optically coupled with a number of optical fibers of the optical fiber connector. The number of the locating poles 631 is not limited to this embodiment. In the embodiment, the two third locating elements are two poles, and the two fourth locating elements are two holes.

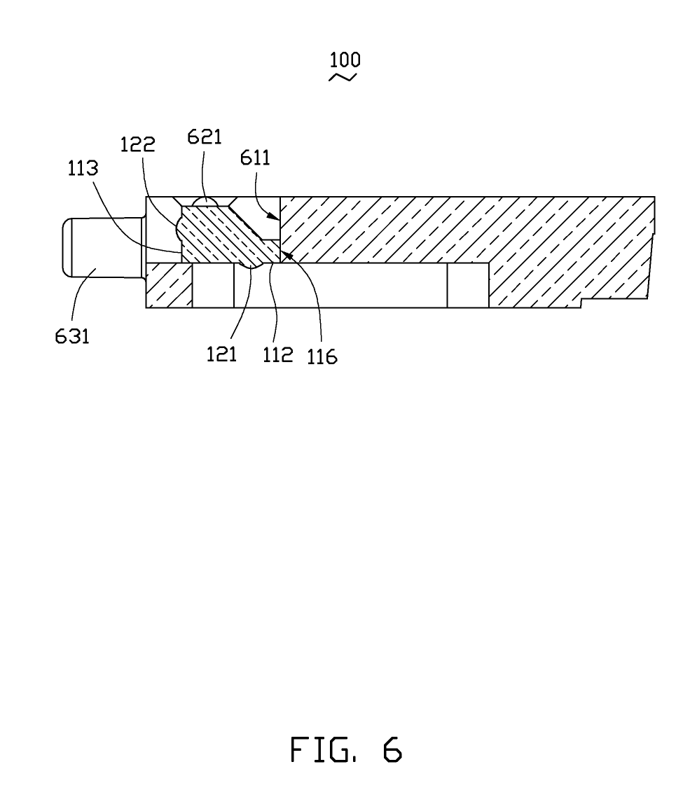

FIG. 6 shows that in assembly, the lens portion 11 is inserted into the slot 630, the abutting surface 115 abuts against the first sidewall 611, the first converging portions 121 are exposed outwards from the slot 630, the second converging portions 122 are exposed outwards from the notch 610. The two second locating elements 621 are inserted into the two first locating elements 130, and thus the main body 10 is fixed to the substrate 60. The fixing grooves 620 may be filled with glue.

In use, light rays from a light emitting module (not shown) are converged by the first converging portions 121, and arrive at the reflecting surface 114. The reflecting surface 114 reflects the light rays into the corresponding second converging portions 122. The second converging portions 122 converge the light rays into the corresponding optical fibers (not shown), and vice versa.

In other embodiments, the abutting surface 115 and the connecting surface 116 can be omitted, and the reflecting surface 114 can be directly connected to the bottom surface 112.

By employing the lens coupling device 100, the main body 10 and the substrate 60 are not integrally formed. Therefore, it is easy to control the precision of a first molding core for manufacturing the main body 10 and a second molding core for manufacturing the substrate 60, and the precisions of the first molding core and the second molding core can be improved. Therefore the product quality of the optical coupling device can be improved.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An optical coupling device, comprising:
a main body comprising:
a lens portion having a bottom surface, a side surface, and a reflecting surface, wherein a plurality of first light converging portions is positioned on the bottom surface, a plurality of second light converging portions is positioned on the side surface and corresponds to the first light converging portions, the reflecting surface is configured for reflecting light rays from the first light converging portions to the second light converging portions, and is further configured for reflecting light rays from the second light converging portions to the first light converging portions, and
at least one connecting portion connected to the lens portion, wherein the at least one connecting portion comprises at least one first locating element;
a substrate comprising:
a contacting wall;
a bottom wall connected to the contacting wall;
a top wall opposite to the bottom wall and connected to the contacting wall, the top wall defining a notch passing through the contacting wall, wherein the substrate defines a slot passing through the bottom wall and communicating with the notch, the main body is detachably received in the notch, the first light converging portions are exposed outwards from the slot, and the second light converging portions are exposed outwards from the notch; and
at least one second locating element positioned on the substrate and engaged with the at least one first locating element to locate the main body on the substrate.

2. The optical coupling device of claim 1, wherein the notch comprises a first sidewall and two opposite second sidewalls, the first sidewall is connected to the two opposite sidewalls, the slot is adjacent to the first sidewall; the shape of the slot is a fit with the shape of the main body.

3. The optical coupling device of claim 2, wherein the main body comprises an abutting surface and a connecting surface, the abutting surface is directly connected to the bottom surface, and is opposite to the side surface, the connecting surface is directly connected to the abutting surface and the reflecting surface, and the abutting surface abuts again the first sidewall.

4. The optical coupling device of claim 2, wherein the top wall defines at least one fixing groove communicated with the notch, the at least one fixing groove receives the at least one connecting portion, and the at least one second locating element is received in the at least one fixing groove.

5. The optical coupling device of claim 4, wherein the number of the at least one connecting portion is two, the number of the at least one fixing groove is two, and the two fixing grooves are respectively defined on the two second sidewalls.

6. The optical coupling device of claim 5, wherein the number of the at least one second locating element is two, and the two second locating elements are respectively positioned on two opposite sides of the notch.

7. The optical coupling device of claim 5, wherein the two connecting portions extend from two opposite sides of the lens portion respectively.

8. The optical coupling device of claim 1, wherein the at least one connecting portion is integrally formed with the lens portion.
